(19) United States
(12) Patent Application Publication
(10) Pub. No.: US 2015/0183525 A1
(43) Pub. Date: Jul. 2, 2015

(54) BEACON LIGHT OPTIC, BEACON LIGHT

(71) Applicant: Orga B.V., Schiedam (NL)

(72) Inventor: Maarten Johannes DE JAGER, Schiedam (NL)

(73) Assignee: Orga B.V., Schiedam (NL)

(21) Appl. No.: 14/261,398

(22) Filed: Apr. 24, 2014

(30) Foreign Application Priority Data
Dec. 27, 2013 (NL) 2012030

(51) Int. Cl. B64D 45/08; F21V 7/06; B63B 22/00; F21V 7/00

(52) U.S. Cl. CPC B64D 45/08; F21V 7/0025; F21V 7/0083; F21V 7/06; B63B 22/00

(57) ABSTRACT

A beacon light optic comprising a plurality of light emitting elements and a light transmitting element arranged above it. The light received in the light transmitting element is divided in at least two beams, each following a different path through their respective segment and being directed to the exit surface of the respective segment. The beacon light optic thus emits light in an angular distribution in a horizontal plane and with a small vertical beam spread.

### CROSS-REFERENCE TO RELATED APPLICATIONS

This application claims priority to Dutch patent application NL 2012030, filed Dec. 27, 2013.

### TECHNICAL FIELD

One or more embodiments may relate to a beacon light which may be used to mark obstructions that may present a hazard to, for example, aircraft or marine vessel navigation.

### BACKGROUND

Beacon lights may be used to emit a relatively small beam over a relatively large azimuthal angle to be visible over a relatively large distance, for example for the aircrafts or marine vessels. In use, i.e. mounted on an obstruction to be marked, the beacon light may emit light in a mainly horizontal beam. A beacon light that is mounted on the obstruction, for example, may emit light outwardly over a 360° azimuthal angular distribution in a horizontal plane to provide an obstruction warning in all directions. The beam spread, i.e. the angle of the beam measured in a vertical plane over which the intensity of the emitted light is greater than 50% of the peak intensity of the emitted light—may be typically on the order of several degrees, e.g. 3 or 5 degrees. In fact, rules and regulations are available that prescribe the requirements that a beacon light needs to fulfill.

A lens or a reflector may be used to collect the light from the light emitting elements and effect therefrom a beam of light. The light emitting elements can be positioned horizontally, such that the light is emitted along a central light emitting axis in the vertical direction. Then, the direction of the light may be changed to a horizontal direction, by a lens and/or a reflector. The light emitting elements can be positioned vertically, such that the light is emitted along a central light emitting axis in the horizontal direction. Then, the light may be collimated to a beam with the desired properties.

Some beacon light optics may be difficult and/or time consuming to assemble. Some optics may become relatively large when multiple light emitting elements are used.

### SUMMARY

Some embodiments may provide for a beacon light with improved characteristics. Some embodiments may provide for a beacon light optic that may be structurally relatively simple and/or may provide for easier manufacturing and/or may provide for easier assembly and/or may provide for more light energy efficiency.

In some embodiments, by providing a light transmitting element with at least a first segment and a second segment, wherein each segment may have at least one exit surface, with the exit surfaces facing in the same direction, a compact construction may be obtained. In an embodiment of the beacon light optic, the light emitting elements may be positioned horizontally, i.e. emitting light mainly vertically, while the beam of light exiting the beacon light optic may be in the horizontal direction.

In some embodiments, by positioning the light emitting elements in the recess of the light transmitting element, such that a light emitting surface of the light emitting elements may be facing the entrance surface, light emitted by the light emitting elements may be received by the light transmitting element.

The light of the light emitting elements may enter the light transmitting element and may be redirected by the light transmitting element over an angle of approximately 90°, i.e. in use from a vertical direction to a horizontal direction, towards the exit surfaces in the exit direction. The exit direction may be the direction along the exit axes in which the light exits from the light transmitting element. In an embodiment, the exit axes may be transverse with respect to the entrance axis of the light transmitting element. In practice, in an embodiment, the exit axes may be mainly parallel to each other.

In an embodiment, by redirecting the light emitted from the light emitting elements, the light emitting elements may be—in use—positioned horizontally, emitting light mainly vertically, while the light transmitting element may generate a horizontal beam. The horizontal positioning of the light emitting elements may be provide for compactness and/or may provide for ease of manufacturing and/or may provide for ease of assembly.

In an embodiment, by providing segments in the light transmitting element, which may be, when seen in a direction along the exit axes, positioned behind each other, the light entering the light transmitting element follows different paths through the light transmitting element, depending on the segment it enters. In an embodiment, by providing different paths for the light entering the light transmitting element, the light may be redirected towards the exit direction in a relatively efficient way. In an embodiment, light losses and/or light pollution may be reduced.

In an embodiment, the exit surfaces may be facing the same direction, i.e. the exit direction, and/or may have exit axes that may be mainly parallel to each other since they may be transverse to the entrance axis. In an embodiment, each segment may be provided with an exit surface. The segments may be disposed behind each other, when seen along the exit direction. In the same view, the exit surfaces may be disposed above each other, to allow the light to exit the segments of the light transmitting element while interference of the light of the different segments with each other may be reduced.

In one embodiment, at least two segments may comprise at least one reflecting surface that may redirect the light in the respective segment. In one embodiment, a first segment may comprise at least two reflecting surfaces for redirecting light towards a second exit surface. The light in the first segment may be redirected twice by the two reflecting surfaces. A first reflecting surface may redirect light towards a second reflecting surface, and the second reflecting surface may redirect the light towards the first exit surface of the first segment, such that the light entered in the first segment may exit along the direction of the first exit axis. The second segment may comprise at least one reflecting surface for redirecting light in the second segment towards the second exit surface. In an embodiment, light entering the second segment may be redirected once, or at least once, towards the second exit surface.

In an example, the reflecting surfaces may be provided as total internal reflecting surfaces. Alternatively and/or additionally, a reflective coating may be applied to an outer side of the light transmitting element to provide for the reflecting surface.

In an embodiment, light in the first segment may travel a longer path than light in the second segment, since light in the first segment may be redirected twice or at least twice and light in the second segment may be redirected once or at least once. It may be advantageous that the first exit surface may be disposed higher than the second exit surface when seen in a direction along the exit axes.

The segments of the reflector each may have a different number of reflecting surfaces. For example, the first segment may comprise two reflecting surfaces and/or the second segment may comprise a single reflecting surface. In another embodiment, a third segment may be provided having a third exit surface with a third exit axis. The third axis may be oriented mainly transverse to the entrance axis, and thus, may be mainly parallel to the first and second exit axes. The third segment may be provided with a reflecting surface, or may be provided without a reflecting surface. In the latter case, light entering the third segment follows a straight path through the third segment to the third exit surface. The third exit surface may be a collimating surface that collimates light exiting from the third segment into a small beam.

In an embodiment, the first segment may comprise a number of reflecting surfaces that may be one more than the number of reflecting surfaces of the second segment. Also, as an example, the second segment may comprise a number of reflecting surfaces that may be one more than the number of reflecting surfaces of a third segment, if present, etc. Also, as an example, a third segment may comprise a number of reflecting surfaces that may be one more than the number of reflecting surfaces of a fourth segment, etc. For example, in one embodiment, the third segment may not comprise a reflecting surface, the second segment may comprise a single reflecting surface and the first segment may comprise two reflecting surfaces. In an advantageous embodiment, each segment may comprise an exit surface.

In an embodiment, the entrance surface of the light transmitting element may be a collimating surface arranged to collimate light from the light emitting elements entering the light transmitting element towards the segments. The entrance surface may have other optical shapes to redirect and/or collimate the light into and/or towards the light transmitting element. In an embodiment, the entrance surface may be arranged to divide light from the light emitting elements entering the light transmitting element into a first subbeam and into a second subbeam and/or into more than two subbeams. The first subbeam may be directed towards the first segment and the second subbeam may be directed towards the second segment. When there may be a third segment or a further segment, the entrance surface may be, in an example, arranged to divide light from the light emitting elements into a third subbeam and a further subbeam as well. Each subbeam may follow a different path through the light transmitting element. The first subbeam may follow a path through the first segment, the second subbeam may follow a path through the second segment, and/or, if there is a third segment, a third subbeam may follow a path through the third segment, etc. Each subbeam may exit its respective segment through the corresponding exit surface, as to form the beam emitted by the light transmitting element.

The beacon light optic and/or the reflector may extend along a linear axis, i.e. a straight line, or along a curved line. The recess in the light transmitting element housing the light emitting elements, may extend along a linear axis or along a curved line as well, depending on the configuration of the reflector. In an embodiment, the plurality of light emitting elements are arranged in the recess side-by-side to each other. In a straight recess, the plurality of light emitting elements are preferably arranged on a straight line along the linear axis of the recess or beacon light optic. In a curved recess, the plurality of light emitting elements are preferably arranged side-by-side to each other along the curved line of the recess or beacon light optic.

Further embodiments may relate to a beacon light comprising at least one beacon light optic. A plurality of straight beacon light optics may be provided that are arranged in juxtaposition to each other at a non-zero angle with the exit surfaces facing outwardly and away from each other. That way, the beacon light may emit light over a large azimuthal angle, i.e. larger than 90°. When sufficient beacon light optics may be arranged, a 360° light output may be obtained. Alternatively and/or additionally, a single or multiple curved beacon light optics may be provided to obtain a light output over more than 90° or even up to 360°.

Further advantageous embodiments are represented in the specification herein, as well as in independent and dependent claims appended thereto.

An embodiment may relate to a method for emitting light outwardly.

Various embodiments will further be elucidated on the basis of exemplary embodiments which are represented in the drawings and accompanying description. The exemplary embodiments are given by way of non-limitative illustrations.

### BRIEF DESCRIPTION OF THE DRAWINGS

In the drawings:

FIG. 1a shows a side view of a first embodiment of a beacon light optic;

FIG. 1b shows a schematic perspective view of the embodiment of FIG. 1a;

FIG. 2a shows a side view of a second embodiment of a beacon light optic;

FIG. 2b shows a schematic perspective view of the embodiment of FIG. 2a;

FIG. 3a shows a side view of a third embodiment of a beacon light optic;

FIG. 3b shows a schematic perspective view of the embodiment of FIG. 3a;

FIG. 4a shows a schematic top view of a configuration of beacon light optics according to FIG. 1a in a beacon light for providing a 360° angular light distribution;

FIG. 4b shows a schematic cross-sectional perspective view of a beacon light with the configuration of beacon light optics of FIG. 4a;

FIG. 5a shows a schematic top view of a configuration of beacon light optics according to FIG. 3a in a beacon light for providing a 360° angular light distribution;

FIG. 5b shows a schematic cross-sectional perspective view of a beacon light with the configuration of beacon light optics of FIG. 5a;

FIG. 6a shows a schematic top view of a beacon light optic with a cross-section according to FIG. 3a extending circular over 360°;

FIG. 6b shows a schematic perspective view of the beacon light optic of FIG. 6a;

FIG. 7a shows a side view of a further embodiment of a beacon light optic;

FIG. 7b shows a schematic perspective view of the embodiment of FIG. 7a;

FIG. 8a shows a side view of a further embodiment of a beacon light optic;

FIG. 8b shows a schematic perspective view of the embodiment of FIG. 8a;

FIG. 9a shows a side view of a further embodiment of a beacon light optic;

FIG. 9b shows a schematic perspective view of the embodiment of FIG. 9a;

FIG. 10 shows a schematic perspective view of a further embodiment of a beacon light optic;

FIG. 11 shows a schematic perspective view of a further embodiment of a beacon light optic;

FIG. 12a shows a cross-section of the embodiment of FIG. 11;

FIG. 12b shows a cross-section of an alternative configuration of the embodiment of FIG. 11.

It is noted that the figures are only schematic representations of embodiments that are given by way of non-limiting examples. In the figures, the same or corresponding parts are designated with the same reference numerals. For the purpose of clarity and a concise description features are described herein as part of the same or separate embodiments. However, it will be appreciated that embodiments having combinations of all or some of the features described are specifically contemplated by the inventor.

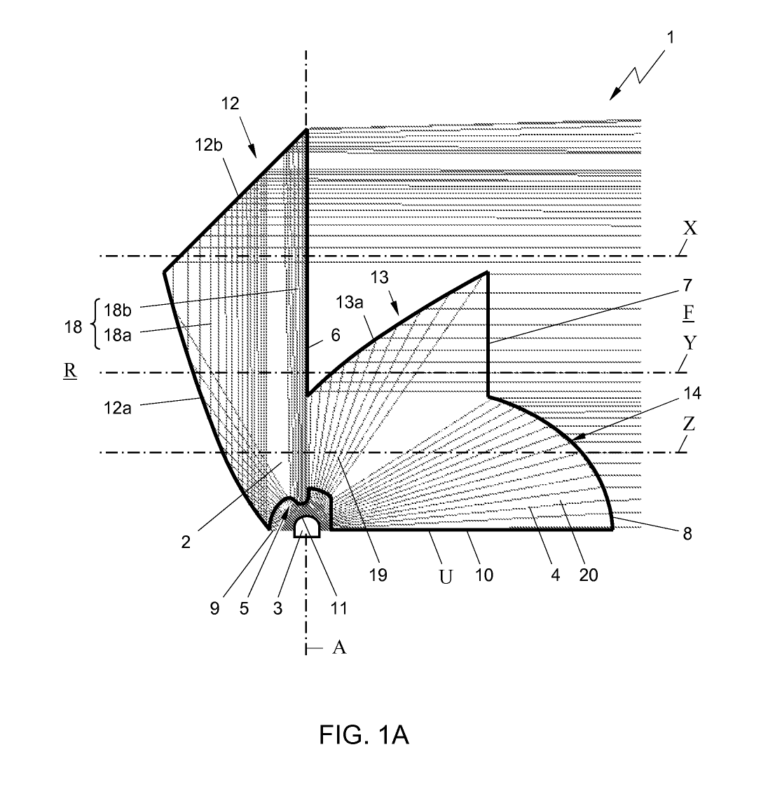

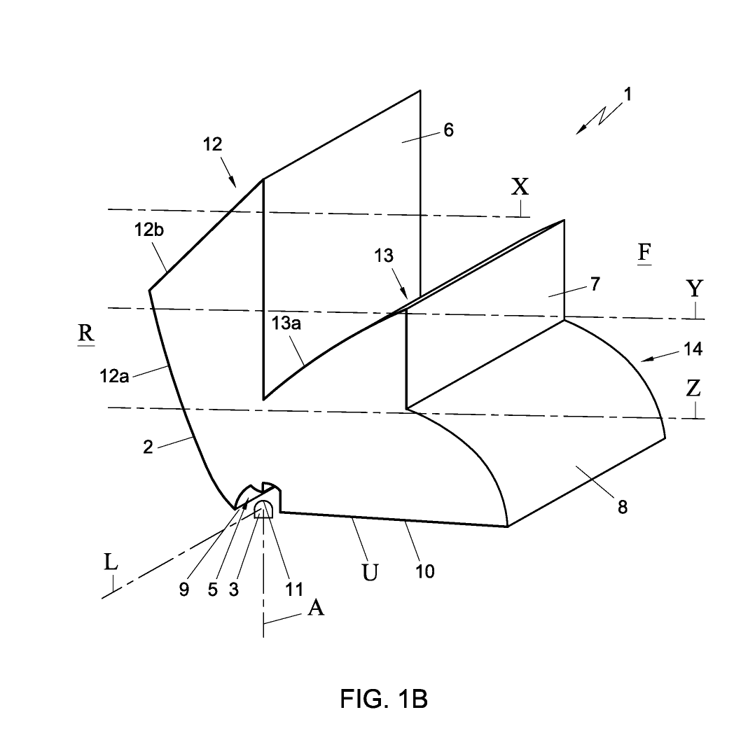

FIGS. 1a-12b are to be understood to present an illustration of various embodiments including exemplary methods and apparatuses. To aid in understanding the embodiments, the features shown in FIGS. 1a-12b are not necessarily drawn to scale, and some well-known features may not necessarily be shown in each embodiment. As is readily apparent to one of skill in the art having knowledge of the present disclosure, various other embodiments of the invention include beacon lights and their exemplary components (e.g., optics, reflectors, etc.), having configurations and elements determined, in part, by their specific use.

### DETAILED DESCRIPTION

FIG. 1a and FIG. 1b show a first exemplary embodiment of a beacon light optic 1 comprising a light transmitting element 2 and a plurality of light emitting elements 3. Due to the cross-sectional view in FIG. 1a and the perspective view in FIG. 1b, only one light emitting element 3 is visible, but, in this embodiment, there is a plurality of light emitting elements 3. The light emitting elements 3 are positioned adjacent to each other. The light emitting elements 3 can be incandescent light sources, but may be, light emitting diodes LEDs. An LED may emit light over approximately a hemisphere, as is schematically shown in FIG. 1a by the lines 4 representing light rays. It is noted that, for simplicity's sake, only a limited number of lines 4 representing the light rays are shown, which is not an exhaustive representation.

The light transmitting element 2 may be a massive, transparent, solid element, for example manufacturing from glass or a suitable plastic material, such as PC, PMMA, etc.

The light transmitting element 2 may comprise an entrance surface 5 and a first exit surface 6, a second exit surface 7 and a third exit surface 8. The entrance surface 5 may have an entrance axis A. The first exit surface 6 may have a first exit axis X, the second exit surface 7 may have a second exit axis Y and the third exit surface 8 may have a third exit axis Z. The exit surfaces 6, 7, 8 may be disposed with respect to the entrance surface 5 such that the exit axes X, Y, Z may be transverse with respect to the entrance axis A. The angle between the exit axes X, Y, Z and the entrance axis A may be approximately and/or substantially and/or about 90°. As a consequence, the exit axes X, Y and Z may be approximately and/or substantially and/or about parallel.

The exit surfaces 6, 7, 8 may be facing in the same direction, meaning that the beacon light optic 1 may emit light substantially and/or about to a single side only. In this embodiment, the exit surfaces 6, 7, 8 face a front side F of the beacon light optic 1. The front side F may be opposite to the rear side R of the beacon light optic 1.

In this embodiment, the entrance surface 5 may define a recess 9 in a bottom 10 at an under side U of the beacon light optic 1. In the recess 9, the plurality of light emitting elements 3 may be disposed. The light emitting elements 3 may be disposed such that a light emitting surface 11 may be facing the entrance surface 5. When mounted, this may mean that a central axis (not shown) of the light emitting elements 3 may be parallel to or may coincide with the entrance axis A of the beacon light optic 1.

The light transmitting element 2 here may comprise three segments 12, 13 and 14. Each segment 12, 13, 14 may have an exit surface 6, 7, 8. The first segment 12 may comprise the first exit surface 6. The second segment 13 may comprise the second exit surface 7 and the third segment 14 may comprise the third exit surface 8. When viewed in a direction along the exit axes X, Y, and Z the segments 12, 13, 14 may be arranged behind each other. For example, as in the embodiment shown in FIG. 1a and FIG. 1b, the first segment 12 may be arranged most to the rear side R, the second segment 13 may be arranged adjacent to the first segment 12 but more to the front side F. The third segment 14 may be arranged adjacent the second segment 13 and most to the front side F. In this configuration, the second segment 13 may be disposed between the first segment 12, more to the rear side R, and the third segment 14, more to the front side F.

In this embodiment, the exit surface 6 located at the most rear position, when seen in a direction from the front side F to the rear side R, may be higher than the exit surfaces 7, 8 located in front thereof. This may be to provide for at least a certain unobstructed surface over which light rays may exit from the first exit surface 6. Similarly, the second exit surface 7 may be higher than and/or may be positioned above the third exit surface 8, as to provide for a certain unobstructed surface over which light may exit from the second exit surface 7.

In an embodiment, the first segment 12 may have two reflecting surfaces 12a, 12b to redirect light entering the first segment 12 towards the first exit surface 6. The light transmitting element 2 may be a massive element, and the reflecting surfaces 12a, 12b may be provided by means of total internal reflection (TIR). Here, in the embodiment shown in FIG. 1a and FIG. 1b, the first segment 12 may comprise two reflecting surfaces 12a, 12b. The second segment 13 may comprise a single reflecting surface 13a and the third segment 14 may not have a reflecting surface. So, the number of reflecting surfaces may differ per segment. Moreover, the first segment 12 may comprise one reflecting surface more than the second segment 13 which may comprise on itself one reflecting surface more than the third segment 14.

The reflecting surfaces 12a, 12b, 13a may redirect light impinging thereupon. The reflecting surface 12a may redirect light towards the reflecting surface 12b. The reflecting surface 12b may redirect light towards the first exit surface 6. The reflecting surface 13a of the second segment 13 may redirect light towards the second exit surface 7.

In this embodiment, the reflecting surfaces 12a and 13a may comprise a parabolic cross-sectional portion. However, the shape of the reflecting surfaces is not limited to a parabolic cross-sectional portion. Any other conic cross-sectional portion shape that is suitable to redirect light from the reflecting surface to either a further reflecting surface and/or to an exit surface may be provided. By providing a parabolic, or other conic, cross-sectional portion, light impinging thereupon may also be collimated to some extent.

In this embodiment, the reflecting surface 12b may be a planar reflecting surface. However, any other shape of the reflecting surface suitable of redirecting the light impinging thereon may be provided.

In the embodiment of FIG. 1a and FIG. 1b the third exit surface 8 may be a collimating exit surface, meaning that the exit surface 8 may collimate the light exiting therethrough to decrease the angular spread of the light in a direction transverse to the exit axis Z. Alternatively, the third exit surface may be absent and/or may be an optically neutral surface.

As can be seen in the embodiment of FIG. 1a and FIG. 1b, the entrance surface 5 may comprise a collimating surface. In particular, the entrance surface 5 may be arranged to divide light emitted by the light emitting elements 3 in three subbeams. There may be a first subbeam 18 directed to the first segment 12, there may be a second subbeam 19 directed to the second segment 13 and there may be a third subbeam 20 directed to the third segment 14. The three subbeams 18, 19, 20 each may follow a different path through the light transmitting element 2. Further, a subbeam itself may be divided in two or more partial subbeams, which is here, in the embodiment of FIG. 1a and FIG. 1b, the case with the first subbeam 18. The first subbeam 18 may be further divided in a partial subbeam 18a and a partial subbeam 18b. The partial subbeam 18a may be directed towards the reflecting surface 12a and then may be redirected towards the reflecting surface 12b to be redirected towards the first exit surface 6. The partial subbeam 18b may be directed towards the reflecting surface 12b and thereafter towards the first exit surface 6. In the embodiment of FIG. 1a and FIG. 1b, the entrance surface 5 receiving light for the partial subbeam 18a may have an optical neutral shape, e.g. a circular cross-sectional shape. The entrance surface 5 receiving light for the partial subbeam 18b may be a collimating surface. The entrance surface 5 receiving light of the subbeam 20 may be a collimating surface. The entrance surface 5 receiving light for the subbeam 19 may have an optical neutral shape. An optical neutral shape may be understood that the shape of the entrance surface does not work on the light rays, so the light rays mainly propagate in the material in the direction with which they were emitted from the light source. Many variants of entrance surfaces are possible, such as optical neutral, collimating, refracting, redirecting, etc. and/or combinations thereof.

In use, the beacon light optic 1 may operate as follows. The light emitting elements 3 may emit light, typically over a hemisphere. Since the light emitting elements 3 may be disposed in the recess formed by the entrance surface 5, light emitted by the light emitting elements 3 may enter the light transmitting element 2 via the entrance surface 5. It may be possible that not all light rays emitted by the light emitting elements 3 may enter the light transmitting element 3, and that minimal losses may occur.

The entrance surface 5 may divide the light received thereon into three subbeams 18, 19 and 20. The first subbeam 18 may be directed to the first segment 12, the second subbeam 19 may be directed to the second segment 13 and the third subbeam 20 may be directed to the third segment 14.

In the first segment 12, at least a partial subbeam 18a may be directed towards the reflecting surface 12a, which has in this embodiment a parabolic cross-sectional portion. The reflecting surface 12a then may collimate, reflect and/or redirect the partial subbeam 18a towards the reflecting surface 12b. Then, the partial subbeam 18a may be reflected and/or redirected by the reflecting surface 12b towards the first exit surface 6. In the second segment 13, the second subbeam 19 may pass through a part of the receiving surface 5 having a neutral shape that may allow the light to enter the segment 13 towards the reflecting surface 13a. The reflecting surface 13a then may collimate, reflect and redirect the subbeam 19 towards the second exit surface 7. In the third segment 14, the third subbeam 20 may be received by a collimating surface of the entrance surface 5 to collimate the subbeam 20 towards the exit surface 8. The exit surface 8 may here be a collimating surface that may further collimate the subbeam 20. Light rays thus exiting from the light transmitting element 2 through the first, second and third exit surfaces 6, 7, 8 may form a beam of light emitted by the beacon light optic 1. The beacon light optic 1 thus may emit light with a narrow beam as prescribed by the requirements of the appropriate rules and regulations, such as ICAO, IALA, FAA, etc.

As can be seen in FIG. 1b, the beacon light optic 1 may extend along a linear axis L. The linear axis L may be oriented transverse to the entrance axis A and transverse to the exit axes X, Y, Z. In fact, the entrance axis A, the linear axis L and the exit axes X, Y, Z may be oriented with respect to each other as the axes of a three-axis Cartesian coordinate system.

The beacon light 1 may linearly extend along the linear axis L. The light transmitting element 2 may extend in longitudinal direction along the linear axis L. It is to be noted that along the linear axis L, the cross-section of the light transmitting element 2 in a plane perpendicular to the linear axis L remains the same in form and dimensions, as is shown in the cross-section of FIG. 1a.

The recess 9 that may be formed by the entrance surface 5 in the bottom 10 of the light transmitting element 2 may extend longitudinally along the linear axis L, thus may form a groove. In the recess 9, the light emitting elements 3 may be disposed such that the light emitting surface 11 of the light emitting element 3 may face the entrance surface 5. The light emitting elements 3 may be disposed in line with each other along the direction of the linear axis L.

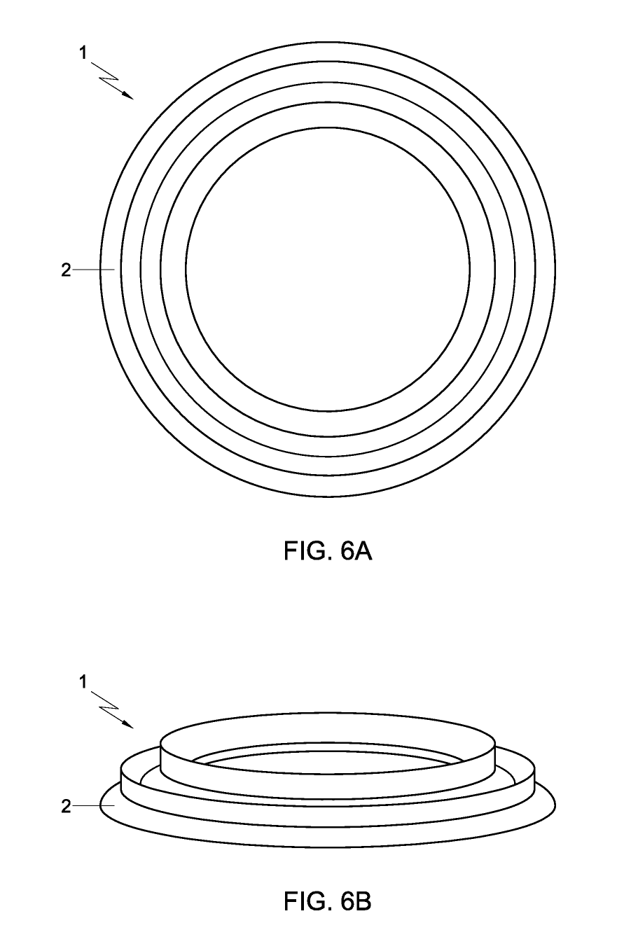

Instead of a longitudinal configuration, in which the beacon light optic extends along a linear axis, the beacon light optic may also extend along a curved line. An example of a beacon light optic 1 extending along a curved line, is shown in FIG. 6a and FIG. 6b. In the embodiment of FIG. 6a and FIG. 6b, the beacon light optic 1 having a light transmitting element 2 with a cross-section as shown in FIG. 1a, extends along a curved line, in this embodiment along a circle line. Here, the light transmitting element 2 may be provided as a single piece element. Alternatively, multiple light transmitting elements 2 may be provided, which each may extend along a curved line having the same radius of curvature. The light transmitting elements 2 may be disposed adjacent to each other with the exit surfaces facing outwardly. The curved lines may be in line with each other at the position of the joint between two light transmitting elements.

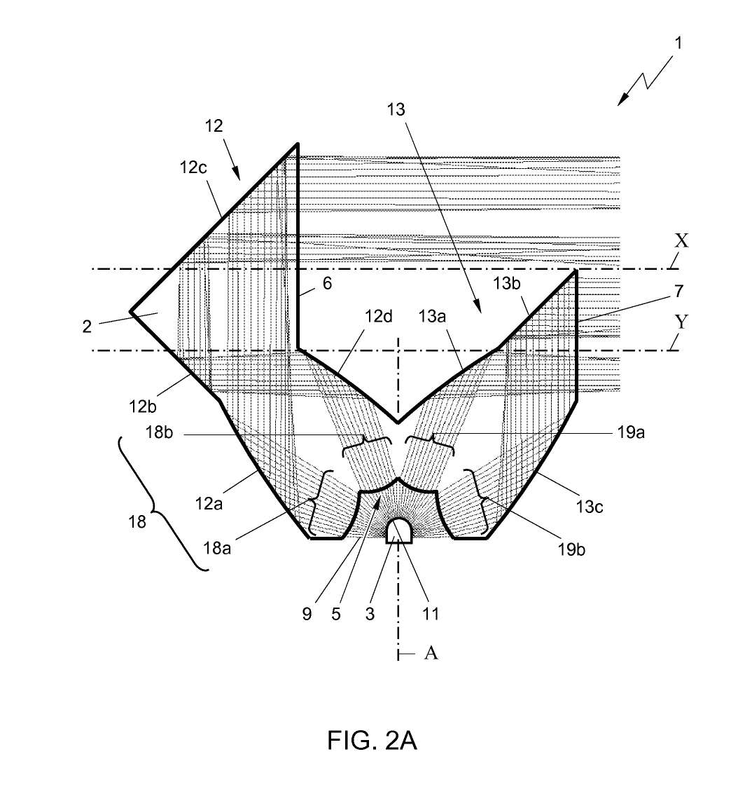

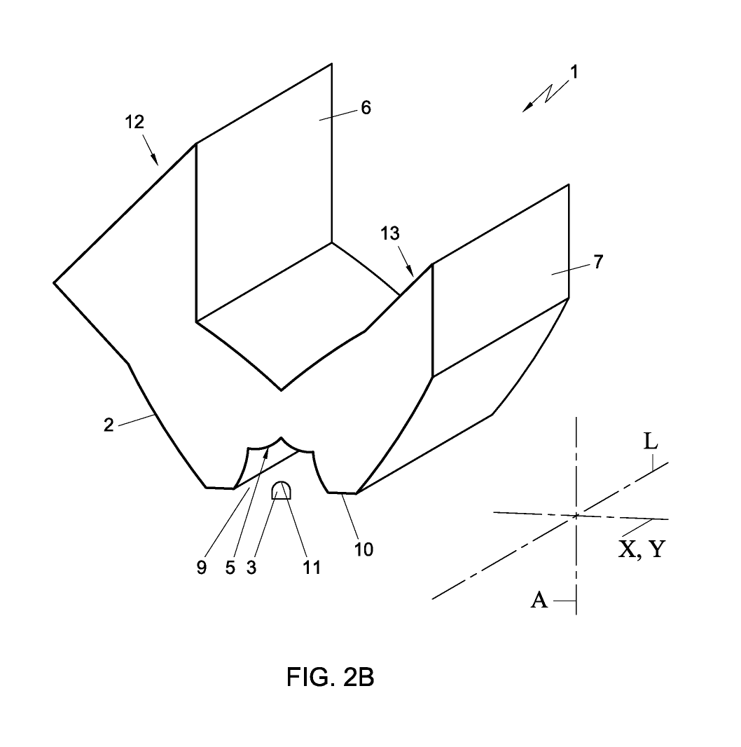

FIG. 2a and FIG. 2b show a second embodiment of the beacon light optic 1. For conciseness' sake, not all features are described, but for features that are the same or similar to the previous embodiments, there is referred to the above description.

The light transmitting element 2 of FIG. 2a and FIG. 2b may comprise two segments, a first segment 12 and a second segment 13. The first segment 12 may have a first exit surface 6 and the second segment 13 may have a second exit surface 7. The first segment 12 may comprise four reflecting surfaces 12a, 12b, 12c, 12d. The second segment 13 may comprise three reflecting surfaces 13a, 13b, 13c. In this embodiment, the first segment 12 and the second segment 13 may have a different number of reflecting surfaces, wherein the first segment 12 may have one more reflecting surface than the second segment 13.

The entrance surface 5 may have a collimating surface and is here arranged to divide light received from the light emitting elements 3 in two subbeams 18 and 19. In addition, the first subbeam 18 may be divided into two partial subbeams 18a and 18b. In the embodiment of FIG. 2a and FIG. 2b, the entrance surface 5 may comprise four parts, which in this embodiment all may be collimating surfaces. Thus, the entrance surface 5 receiving light for the first subbeam 18a may collimate the first subbeam 18a towards the reflecting surface 12a. The entrance surface 5 receiving light for the second subbeam 18b may collimate the second subbeam 18b towards the reflecting surface 12d. The entrance surface 5 receiving light for the first subbeam 19a may collimate the first subbeam 19a towards the reflecting surface 13a. The entrance surface 5 receiving light for the second subbeam 19b may collimate the second subbeam 19b towards the reflecting surface 13c.

The first subbeam 18 may be directed to the first segment 12. The second subbeam 19 may be directed to the second segment 13. The first partial subbeam 18a may be collimated to the reflecting surface 12a and therefrom towards the reflecting surface 12c which may redirect the light of the first partial subbeam 18a to the first exit surface 6. The second partial subbeam 18b may be collimated to the reflecting surface 12d, from there it may be redirected towards the reflecting surface 12b which may redirect the light of the second partial subbeam 18b to the reflecting surface 12c. The reflecting surface 12c finally may redirect the light towards the first exit surface 6.

The second subbeam 19 may also be divided into two partial subbeams 19a, 19b by the entrance surface 5. The first partial subbeam 19a may be collimated to the reflecting surface 13a which may redirect the light towards the second exit surface 7. The second partial subbeam 19b may be reflected and/or redirected twice, first by the reflecting surface 13c and then by the reflecting surface 13b which finally may redirect the light towards the second exit surface 7.

Similar to the first embodiment, the beacon light optic 2 of the second embodiment may extend in longitudinal direction along a linear axis L, as shown in FIG. 2b. Alternatively, the beacon light optic 2 may extend along a curved line.

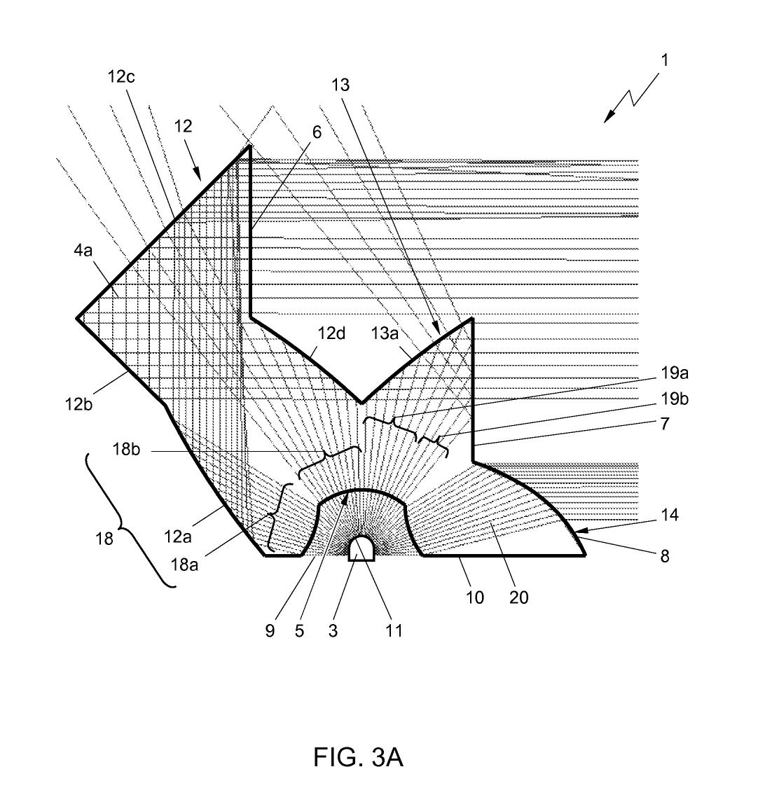

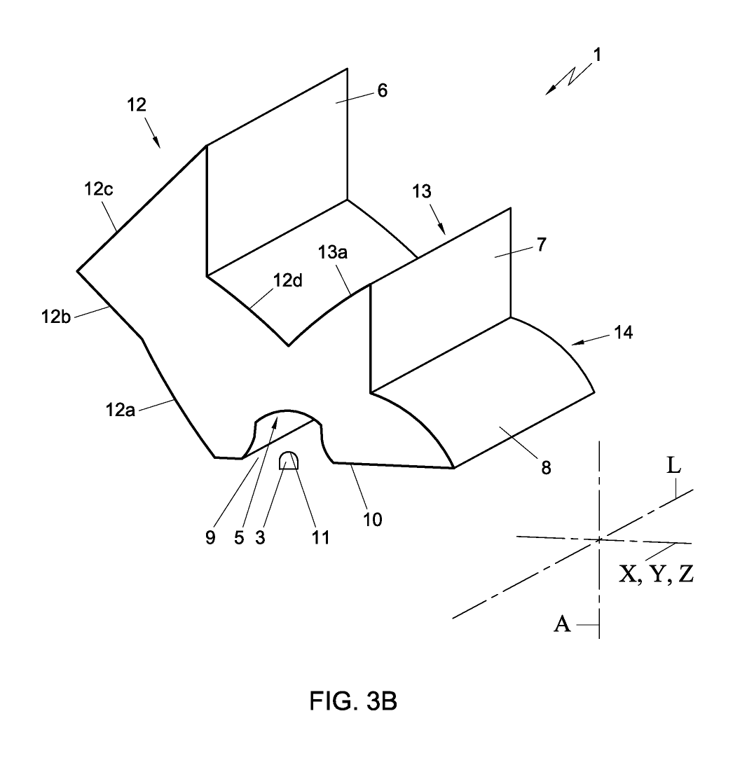

In the third embodiment of a beacon light optic 2, shown in FIG. 3a and FIG. 3b, there may be—similar to the first embodiment—three segments. The first segment 12 may comprise reflecting surfaces 12a, 12b, 12c and 12d. The second segment 13 may comprise reflecting surface 13a. The third segment 14 may not comprise a reflecting surface, but may comprise a—collimating and/or optically neutral—exit surface 8. The entrance surface 5 may be, here too, arranged to divide light emitted from the light emitting elements 3 into three subbeams, a first subbeam 18 may be directed to the first segment 12, a second subbeam 19 may be directed to the second segment 13 and a third subbeam 20 may be directed to the third segment 14. The entrance surface 5 here may comprise collimating surfaces and an optical neutral surface.

The first subbeam 18 may further be divided into two partial subbeams 18a and 18b. The entrance surface 5 receiving light for the first partial subbeam 18a may collimate it to the reflecting surface 12a. The first partial subbeam 18a may be reflected twice, first by the reflecting surface 12a, then by the reflecting surface 12c. The reflecting surface 12c may redirect the partial subbeam 18a towards the first exit surface 6.

The entrance surface 5 may have a neutral shaped surface that may be arranged to receive light for the second partial subbeam 18b and for the second subbeam 19. The entrance surface 5 receiving light for the second partial subbeam 18a may collimate it to the reflecting surface 12d. The second partial subbeam 18b may be redirected three times, first by the reflecting surface 12d which may reflect and/or redirect light to the reflecting surface 12b which may reflect and/or redirect light towards the reflecting surface 12c that may reflect and/or redirect light to the first exit surface 6. As may be seen in the embodiment of FIG. 3a, some light rays of the first subbeam 18 may exit the beacon light optic via the surface 12c, which may cause some minimal loss of light. However, such lost light is minimal and the light rays 4a may exit upwardly, thus not causing pollution of the horizontal beam emitted by the beacon light optic 1.

The entrance surface 5 receiving light for the second subbeam 19 may have a neutral shaped surface which may receive light for the second partial subbeam 18b. The second subbeam 19 may enter the entrance surface 5 and may propagate towards the reflecting surface 13a. Part of the subbeam 19, the first partial subbeam 19a, may be reflected and/or redirected by the reflecting surface 13a which may further reflect and/or redirect the light towards the second exit surface 7. Part of the subbeam 19, the second partial subbeam 19b, may impinge upon the exit surface 7, and depending on the angle of incidence, may be redirected away from the exit surface 7. This too may cause minimal loss of light, which however may be neglectable in terms of the overall performance of the beacon light optic 1.

The third subbeam 20 may be collimated by the entrance surface 5 towards the third exit surface 8 which further may collimate the light passing therethrough.

Similar to the other embodiments, the beacon light optic 1 and light transmitting element 2 may extend along a linear axis L, in a direction transverse to the entrance axis A and transverse to the exit axes X, Y, Z.

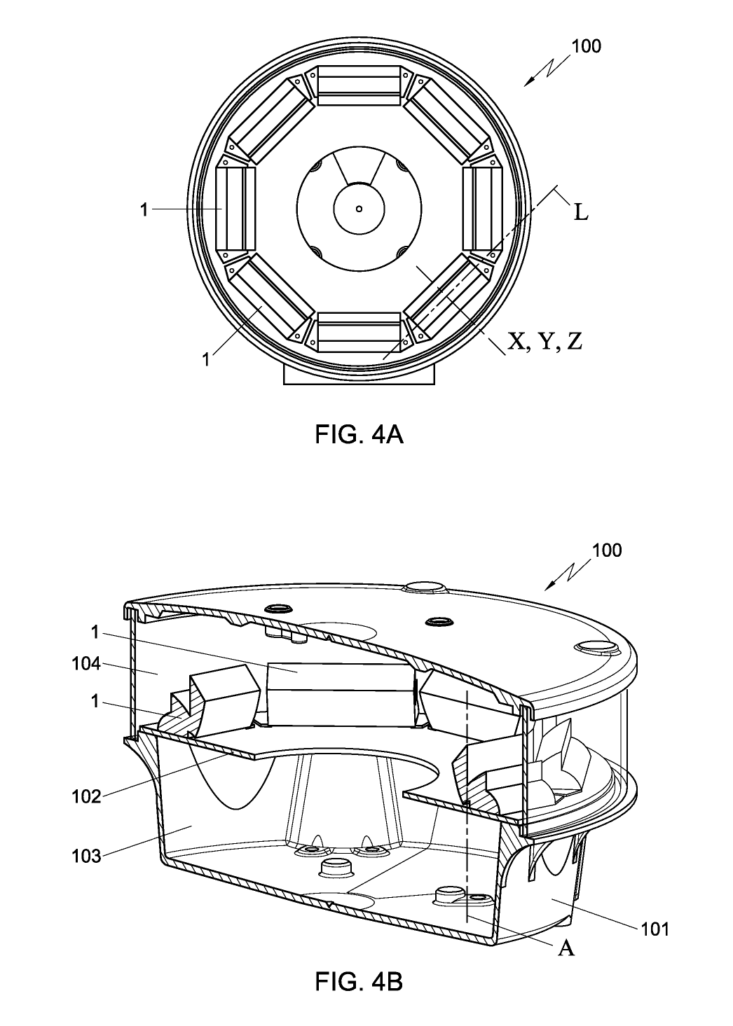

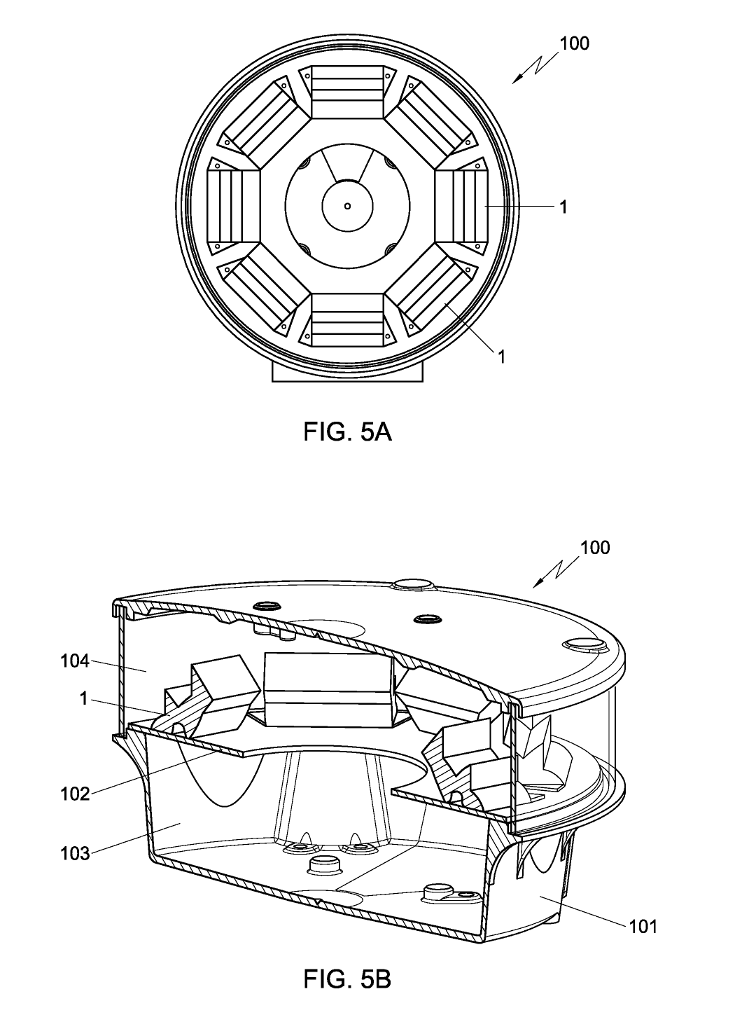

FIG. 4a, FIG. 4b and FIG. 5a, FIG. 5b show embodiments of a beacon light 100 comprising embodiments of beacon light optics 1. In the embodiment of FIG. 4a and FIG. 4b the beacon light optic 1 of FIG. 1a and FIG. 1b is used. In the embodiment of FIG. 5a and FIG. 5b the beacon light optic 1 of FIG. 3a and FIG. 3b is used.

The beacon light optics 1 may be positioned in the beacon light with the entrance axis A arranged vertical and the exit axes X, Y, Z arranged horizontally. The beacon light optics 1 may extend longitudinally along the linear axis L. The beacon light optics 1 may be arranged in juxtaposition to each other at non-zero angle with their respective exit surfaces 6, 7, 8 facing outwardly and away from each other, such that a relatively large angular distribution may be obtained in a horizontal plane by the light emitted by adjacent beacon light optics 1. In the embodiment of FIG. 4a or FIG. 5a eight beacon light optics 1 may be provided and may be positioned octagonal to provide for a 360° angular distribution of the light by the beacon light 100.

Alternatively and/or additionally, beacon light optics 1 extending along a curved line or a beacon light optic extending circular, as for example in FIG. 6a and FIG. 6b, may be used to provide for a 360° angular distribution of the light by the beacon light 100.

The beacon light optic 100 further may comprise a housing 101 in which the beacon light optics 1 may be arranged. In the housing 101 a plate 102 may be provided which may divide the housing in a lower space 103 and an upper space 104. In the lower space 103, electronical equipment, cooling, transformer and/or power supply may be arranged that may be used to control and/or feed the beacon light optics 1 which may be mounted on the plate 102 in the upper space 104. Alternatively and/or additionally, multiple plates 102 may be provided arranged above each other as to stack the beacon light optics mounted on the plates 102. The beacon light may thus become larger and/or more intense, depending on the requirements set.

The upper part 104 may be circumferentially closed by a transparent cover, preferably from plastic, which may allow the light emitted by the beacon light optics to pass through outwardly. Instead of transparent, the cover may be translucent and/or partly transparent and/or partly translucent.

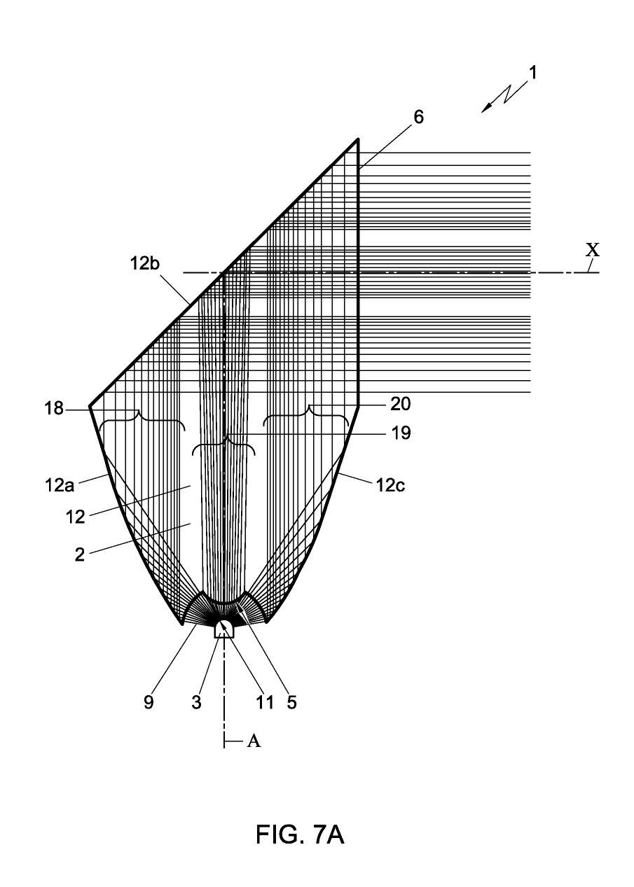

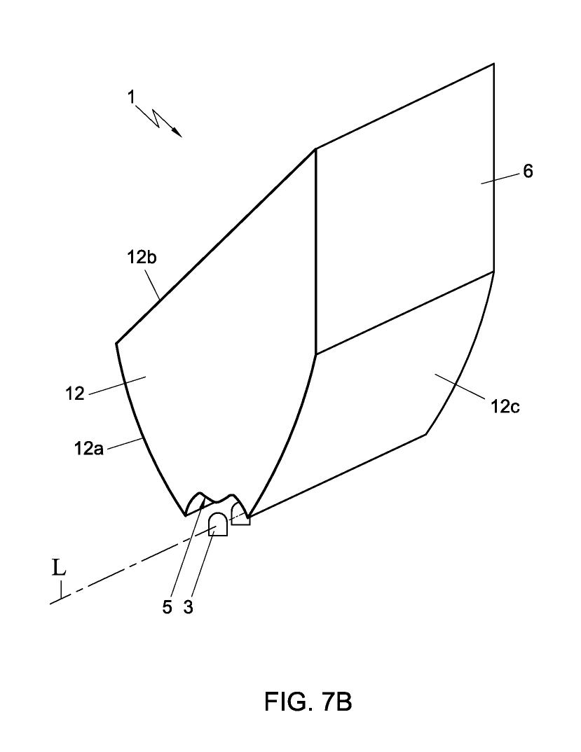

FIG. 7a shows schematically a cross-section of another embodiment of a beacon light optic 1 comprising a light transmitting element 2 and light emitting elements 3. FIG. 7b shows a perspective view of the embodiment of FIG. 7a. In FIG. 7b only the optic 1 and the light emitting elements 3 may be shown. Other features which may be provided to install and/or assembly the optic 1 and the light emitting elements 3 into a beacon light have not been shown.

The light transmitting element 2 may comprise a segment 12. The segment 12 may have an exit surface 6. The exit surface 6 may have an exit axis X. The segment 12 may have a first reflecting surface 12a, a second reflecting surface 12b and a third reflecting surface 12c.

The light transmitting element 2 may have an entrance surface 5. The entrance surface 5 may form a recess or a groove 6 at an underside of the light transmitting element 2. In the recess 6, the light emitting elements 3 may be arranged. The light emitting elements 3 may be arranged with a light emitting surface 11 facing the entrance surface 5. The light emitting elements 3 may have a central light emitting axis A. In this embodiment, the axis A may be transverse with respect to the axis X.

The entrance surface 5 may be arranged to divide the light received from the light emitting elements 3 into three subbeams 18, 19, 20. The entrance surface 5 may have a partly collimating surface and/or may have a partly optical neutral surface.

The first subbeam 18 may be directed towards the first reflecting surface 12a, and then may be reflected and/or redirected towards the second reflecting surface 12b. The second reflecting surface 12b then may reflect and/or redirect the subbeam towards the exit surface 6 in an exit direction along the axis X. The second subbeam 19 may be directed towards the second reflecting surface 12b. The second reflecting surface 12b may then reflect and/or redirect the light towards the exit surface 6. The third subbeam 20 may be directed towards the third reflecting surface 12c and may then be reflected and/or redirected towards the second reflecting surface 12b which may then reflect and/or redirect the light of the subbeam 20 towards the exit surface 6. In this embodiment reflects and/or redirects the second reflecting surface 12b light from the first, second and third subbeams 18, 19, 20 as to form the beam that may be emitted by the beacon light optic 1.

In this embodiment, the first reflecting surface 12a may have a parabolic and/or conic cross-sectional portion. The second reflecting surface 12b may be a planar reflecting surface, the third reflecting surface 12c may have a parabolic and/or conic cross-sectional portion. The second reflecting surface 12b may be positioned under an angle of approximately and/or substantially and/or about 45° with respect to the axis A and/or with respect to the axis X.

In this embodiment, the beacon light optic 1 may extend linearly along an axis L. The light emitting elements 3 may be provided in an array in the recess 9.

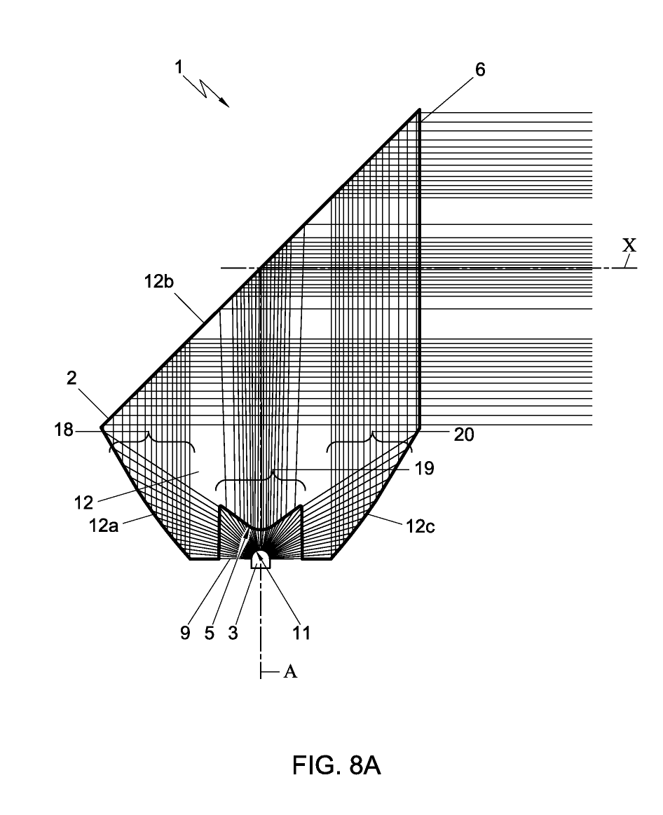

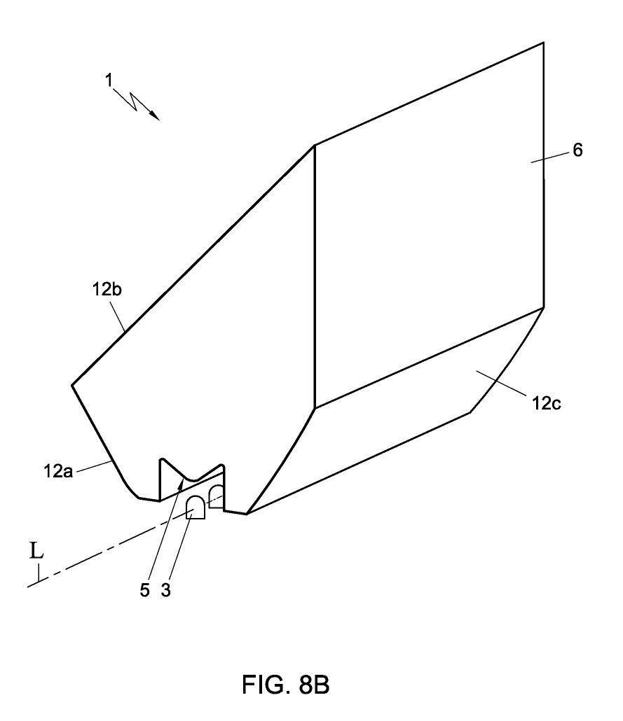

FIG. 8a and FIG. 8b show a different embodiment of a beacon light optic 1. The embodiment is similar to the embodiment of FIG. 7a and FIG. 7b. The beacon light optic 1 may have a light transmitting element 2 with a plurality of light emitting elements 3. The light transmitting element 2 may have a first reflecting surface 12a, a second reflecting surface 12b and a third reflecting surface 12c.

The light transmitting element 2 may have an entrance surface 5. The entrance surface 5 may form a recess or a groove 6 at an underside of the light transmitting element 2. In the recess 6, the light emitting elements 3 may be arranged. The light emitting elements 3 may be arranged with a light emitting surface 11 facing the entrance surface 5. The light emitting elements 3 may have a central light emitting axis A. In this embodiment, the axis A may be transverse with respect to the axis X.

The entrance surface 5 may be arranged to divide the light received from the light emitting elements 3 into three subbeams 18, 19, 20. The entrance surface 5 may have a partly collimating surface and/or may have a partly optical neutral surface.

The first subbeam 18 may be directed towards the first reflecting surface 12a, and then may be reflected and/or redirected towards the second reflecting surface 12b. The second reflecting surface 12b then may reflect and/or redirect the subbeam towards the exit surface 6 in an exit direction along the axis X. The second subbeam 19 may be directed towards the second reflecting surface 12b. The second reflecting surface 12b may then reflect and/or redirect the light towards the exit surface 6. The third subbeam 20 may be directed towards the third reflecting surface 12c and may then be reflected and/or redirected towards the second reflecting surface 12b which may then reflect and/or redirect the light of the subbeam 20 towards the exit surface 6. In this embodiment reflects and/or redirects the second reflecting surface 12b light from the first, second and third subbeams 18, 19, 20 as to form the beam that may be emitted by the beacon light optic 1.

In this embodiment, the first reflecting surface 12a may have a parabolic and/or conic cross-sectional portion. The second reflecting surface 12b may be a planar reflecting surface, the third reflecting surface 12c may have a parabolic and/or conic cross-sectional portion. The second reflecting surface 12b may be positioned under an angle of approximately and/or substantially and/or about 45° with respect to the axis A and/or with respect to the axis X.

In this embodiment, the beacon light optic 1 may extend linearly along an axis L. The light emitting elements 3 may be provided in an array in the recess 9.

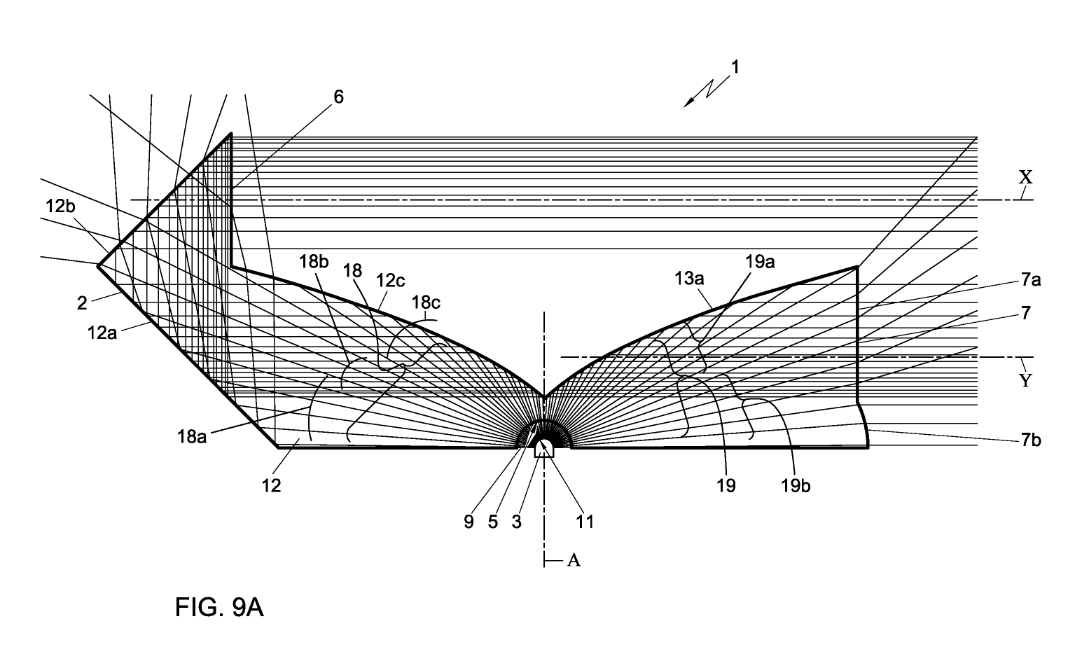

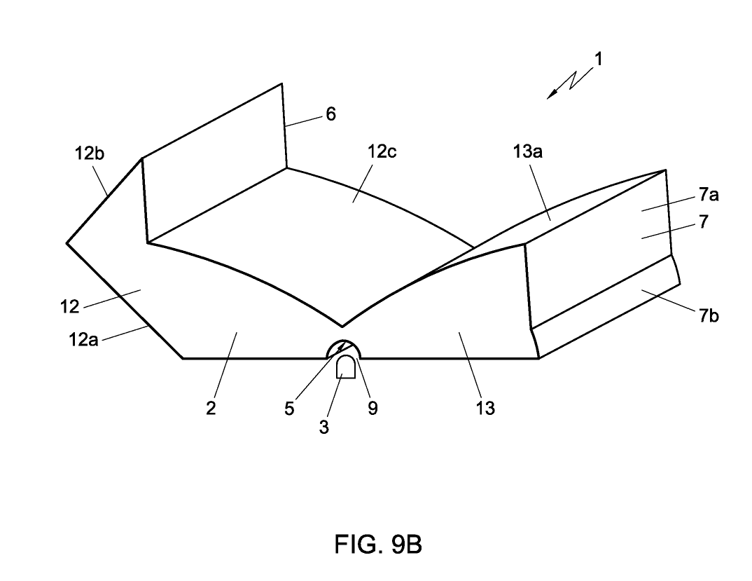

FIG. 9a and FIG. 9b show another embodiment of a beacon light optic 1. The beacon light optic 1 may comprise a light transmitting element 2 and a plurality of light emitting elements 3. The light emitting elements 3 may be arranged in a recess 9 that may be formed by an entrance surface 5 at an underside of the light transmitting element 2. The entrance surface 5 may comprise a collimating part and/or may comprise an optical neutral part. The entrance surface 5 may be arranged to divide light emitted by the light emitting elements 3 which may be received by the entrance surface 5.

The light transmitting element 2 may comprise two segments, a first segment 12 and a second segment 13, as in this embodiment. The first segment 12 may comprise a first reflecting surface 12a, a second reflecting surface 12b and a third reflecting surface 12c. The first segment 12 may comprise a first exit surface 6 that may have a first exit axis X. The second segment 13 may have a first reflecting surface 13a and may have a second exit surface 7 that may have a second exit axis Y.

The reflecting surfaces may be planar, as for example reflecting surfaces 12a and 12b. The reflecting surfaces may have a parabolic and/or conic cross-sectional portion. Planar reflecting surfaces may be positioned under an angle with respect to the central light emitting axis A of the light emitting element 3 and/or may be positioned under an angle with respect to the exit axis X and/or Y.

Light emitting by the light emitting elements 3 may enter the first segment 12 in a first subbeam 18. The first subbeam 18 may have a first partial subbeam 18a that may comprise light impinging on the first reflecting surface 12a. The first reflecting surface 12a may reflecting and/or redirect the light of the first subbeam 18a to the second reflecting surface 12b which may reflect and/or redirect the light towards the first exit surface 6. Light of a second partial subbeam 18b may impinge onto the second reflecting surface 12b, and may be reflected and/or redirected towards the first exit surface 6 and/or, depending on the angle of incidence, may be reflected and/or redirected in a different direction. This may cause some minor loss of lights, which may however be neglectable in view of the overall performance of the beacon light optic 1. Light of a third subbeam 18c may impinge upon the third reflecting surface 12c and may be reflected and/or redirected towards the first reflecting surface 12a. The first reflecting surface 12a may then reflect and/or redirect the light of the third subbeam 18c towards the second reflecting surface 12b which may reflect and/or redirect it towards the first exit surface 6.

Light entering the second segment 13 may be light of the second subbeam 19. Part of the light of the second subbeam 19, forming the first partial subbeam 19a, may be reflected and/or redirected by the first reflecting surface 13a towards the second exit surface 7. Part of the light of the second subbeam 19, which may form the second partial subbeam 19b, may be directed towards the second exit surface 7. Depending on the angle of incidence of the light rays of the second partial subbeam 19b on the exit surface 7, some light rays may be redirected towards a direction different from the exit direction along the exit axis Y. This may cause some light loss, albeit minor in view of the overall performance of the beacon light optic 1.

The beacon light optic 1 may extend linearly along a longitudinal axis L. The light emitting elements 3 may be arranged in an array in the recess 9 that may be formed by the entrance surface 5.

In this embodiment, the exit axes X and Y may be parallel and/or may be transverse with respect to the light emitting axis A.

In the embodiment of FIG. 8a and FIG. 8b, the exit surface 7 may have a part that may be planar, part 7a and/or may have a part that may be collimating, part 7b. In other embodiments, the part 7b may be obviated and/or may have a different shape.

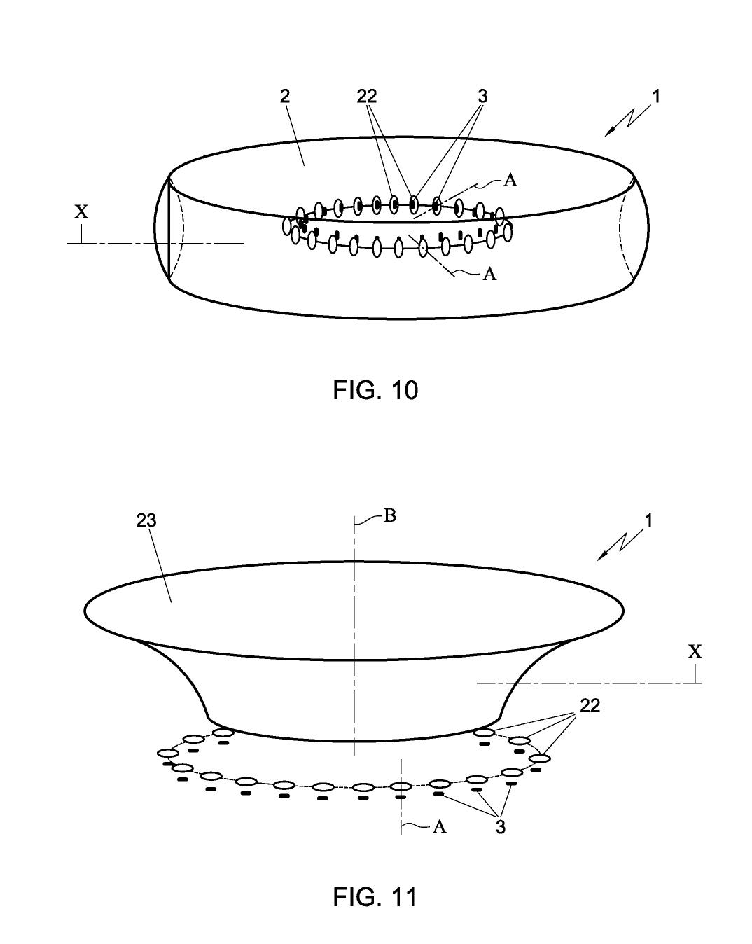

FIG. 10 shows schematically a further embodiment of a beacon light optic 1. The beacon light optic 1 may comprise a plurality of light emitting elements 3 and a light transmitting element 2. In this embodiment, the beacon light optic 1 may comprise lenses 22. It may be appreciated that the embodiment in FIG. 10 is shown simplified. Features present to install and/or assemble the beacon light optic 1 into a beacon light have been omitted for conciseness' reasons. For example, a structure on which the light emitting elements may be mounted may not be shown.

The light emitting elements 3 may be arranged in a curved configuration, for example the light emitting elements 3 may be arranged on a circular line. A configuration in other curved lines may also be possible, e.g. an elliptical line. In this embodiment, the light emitting elements 3 are mounted vertically, i.e. the central light emitting axis A may be arranged horizontally. In this embodiment, in front of each light emitting element 3 a lens 22 may be provided. The lens 22 may be provided such that a light emitting surface 11 of the light emitting element 3 may face a light entrance surface of the lens 22. The lens 22 may collimate and/or may focus the light emitted by the light emitting element 3. Further outwardly, a light transmitting element 2 may be provided. The light transmitting element 2 may be arranged in front of the lenses 22. The light transmitting element 2 may be a single piece and/or may be multiple pieces that may be positioned adjacent to each other. In this configuration, the light emitting elements 3 may be positioned inwardly. More or less directly in front of each light emitting element 3 a lens 22 may be provided, outwardly from the light emitting element 3. More outwardly from the light emitting elements 3 the light transmitting element 2 may be provided. The light transmitting element 3 may have an exit axis X. In this embodiment, the exit axis X may be parallel to the light emitting axis A. The light transmitting element 2 may extend over an azimuthal angle of 360° and/or may extend over a smaller azimuthal angle. Multiple light transmitting elements 2 may then be positioned adjacent each other to cover the azimuthal angle of 360°.

FIG. 11 shows another embodiment of the beacon light optic 1. The beacon light optic 1 may comprise a plurality of light emitting elements 3. In this embodiment, lenses 22 may be positioned relatively close to the light emitting elements 3. In this embodiment, each light emitting element 3 may be provided with a corresponding lens 22. The corresponding lens 22 may be positioned substantially and/or about directly above the light emitting element 3 such that a light emitting surface of the light emitting element 3 faces an entrance surface of the lens 22. The light emitting elements 3 may be positioned horizontally, such that a central light emitting axis A may be positioned vertically. Further, the beacon light optic 1 comprises a reflecting surface 23 that may extend along a curved line. The reflecting surface 23 may be a reflecting surface extending over an azimuthal angle of 360° and/or may extending over a smaller azimuthal angle than 360°. The multiple reflecting surfaces 23 may be curved and may be positioned adjacent each other to extend along a curved line over an azimuthal angle of 360° or a part thereof. In the embodiment of FIG. 11 a reflecting surface 23 extending along a circular line around a central axis B is shown. The reflecting surface 23 may be a revolving reflecting surface. Additionally and/or alternatively other embodiments of a curved line may be possible, e.g. an elliptical line or an oval line, etc. Additionally and/or alternatively, the reflecting surface 23 may extend along a straight line. Multiple segments extending along a straight line may then be positioned in a polygonal configuration, e.g. hexagonal or octagonal, to form a beacon light that may exit a beam of light around an azimuthal angle of 360° or a part thereof.

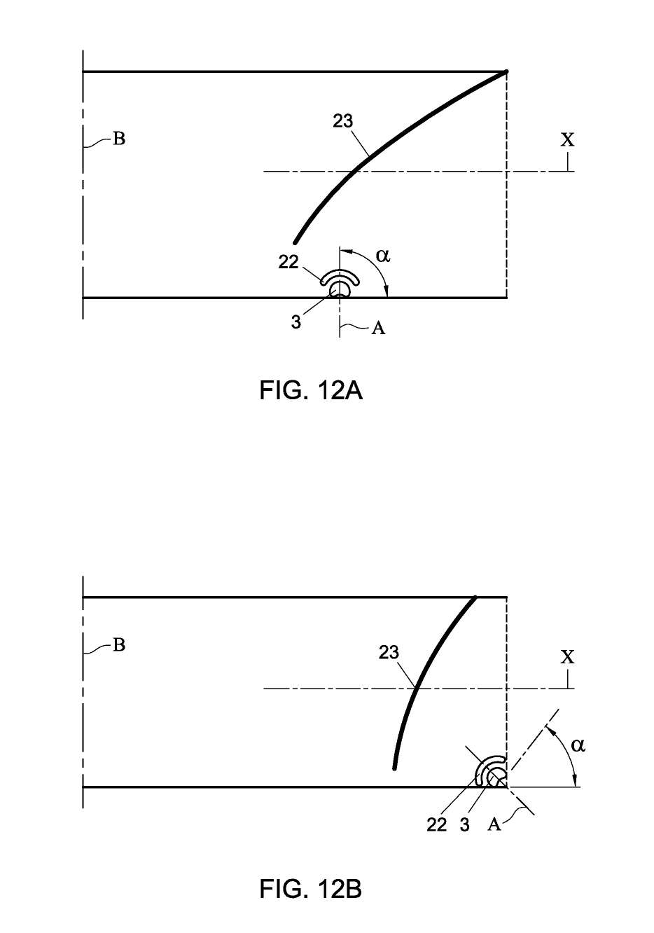

Light emitted by the light emitting element 3 may be collimated and/or focused by the lens 22 towards the reflecting surface 23. The reflecting surface 23 may then reflect and/or redirect the light outwardly in the direction of the exit axis X. In FIG. 12a a cross-section of the embodiment of FIG. 11 is shown with a light emitting element 3 having a light emitting axis A extending upwardly. The light emitting axis A may then extend transverse with respect to the exit axis X of the reflecting surface 23. The angle α between the light emitting axis A may then be substantially and/or about 90°. In the embodiment of FIG. 12b is shown that the light emitting element 3 may be positioned under an angle with respect to the exit axis X. The angle α between the light emitting axis A may then be substantially and/or about 45°.

A beacon light optic may comprise a plurality of light emitting elements and a light transmitting element arranged above it. The light received in the light transmitting element may be divided in at least two beams, which each may follow a different path through their respective segment and which may be directed to the exit surface of the respective segment. The beacon light optic thus may emit light in an angular distribution in a horizontal plane and with a relatively small vertical beam spread. Embodiments of the beacon light optic may be arranged into a housing to form a beacon light. For conciseness' sake, beacon light optics have been discussed and features which may be present for assembly and/or installation of a beacon light optic into a beacon light may have been omitted.

In view of the present disclosure, it will be seen that several advantages may be achieved and other advantageous results may be obtained. Those having skill in the art, with the knowledge gained from the present disclosure, will recognize that various changes could be made in the above embodiments without departing from the scope of the embodiments herein. Further, features and aspects of one embodiment may be combined with features and aspects of other embodiments in accordance with the teachings herein.

1. A beacon light optic comprising
at least one light emitting element
a first reflective segment having at least two reflecting surfaces configured to reflect a first subbeam of light emitted from the light emitting element outward through a first exit surface, and
a second reflective segment having at least one reflecting surface configured to convey a second subbeam of light emitted from the light emitting element outward through a second exit surface.

2. The beacon light optic of claim 1, further comprising
a light transmitting element having an entrance surface with an entrance axis and including the first and second exit surfaces, wherein the first and second exit surfaces have first and second exit axes, respectively, and are disposed with respect to the entrance surface such that the first and second exit axes are transverse with respect to the entrance axis and the exit surfaces face the same direction,
wherein the entrance surface defines a recess in the light transmitting element,
wherein the a least one light emitting element is a plurality of light emitting elements arranged in the recess of the light transmitting element such that a light emitting surface of the light emitting elements faces the entrance surface,
wherein the light transmitting element comprises the first and second reflective segments, and
wherein the segments are arranged behind each other in the direction of the first and second exit axes.

3. The beacon light optic of claim 1, wherein at least one of the first and second reflecting surfaces of the first reflective segment, or the reflecting surface of the second reflective segment comprises a parabolic cross-sectional portion.

4. The beacon light optic of claim 1, wherein the first and second reflective segments have a different number of reflecting surfaces.

5. The beacon light optic of claim 1, further comprising a third reflective segment configured to direct light through a third exit surface having a third exit axis.

6. The beacon light optic of claim 5, wherein the third exit surface is transverse with respect to the entrance axis and faces the same direction as the first and the second exit surfaces.

7. The beacon light optic of claim 1, wherein at least one of first and second exit surfaces is a collimating exit surface.

8. The beacon light optic of claim 2, wherein the entrance surface comprises a collimating surface.

9. The beacon light optic of claim 1, wherein the entrance surface is arranged to divide light emitted by the light emitting elements into the first subbeam and the second subbeam, wherein the first subbeam is directed towards the first reflective segment and the second subbeam is directed towards the second reflective segment.

10. The beacon light optic of claim 2, wherein the light transmitting element extends along a linear axis in a direction transverse to the entrance axis and transverse to the first and second exit axes.

11. The beacon light optic of claim 10, wherein the recess is oriented linearly in the direction of the linear axis.

12. The beacon light optic of claim 10, wherein the plurality of light emitting elements are arranged in a linear configuration in the recess in the direction of the linear axis.

13. The beacon light optic of claim 2, wherein the light transmitting element extends along a curve in a direction transverse to the entrance axis and transverse to the first and second exit axes.

14. A beacon light, comprising at least one beacon light optic according to claim 1.

15. The beacon light of claim 14, wherein, in the beacon light optic, the entrance axis is oriented vertically and the exit axis is oriented horizontally.

16. The beacon light according to claim 14, comprising a plurality of beacon light optics extending along a linear axis and arranged in juxtaposition to each other at a non-zero angle with their respective exit surfaces facing outwardly and away from each other.

17. The beacon light according to claim 14, comprising a plurality of beacon light optics extending along a curved line having a constant radius of curvature and being arranged in juxtaposition to each other.

18. The beacon light according to claim 14, comprising a single beacon light optic extending 360° or multiple beacon light optics arranged in juxtaposition to each other with their respective exit surfaces facing outwardly to provide for a light exit over 360°.

19. The beacon light according to claim 14, comprising said at least one beacon light optic or a plurality of beacon light optics and further comprising an additional single beacon light optic extending over 360° or an additional plurality of beacon light optics arranged in juxtaposition to each other with their respective exit surfaces facing outwardly to provide for a light exit over 360°, wherein the additional single beacon light optic or the additional plurality of beacon light optics are stacked on top of said at least one beacon light optic or said plurality of beacon light optics, respectively.

20. A method for emitting light, the method comprising
reflecting a first subbeam of light, emitted from a light emitting element, to at least two reflecting surfaces and outward through a first exit surface of a beacon light optic, and
reflecting a second subbeam of light, emitted from the light emitting element, to at least one reflecting surface and outward through a second exit surface of the beacon light optic,
wherein the light is emitted over an azimuthal angle of at least 90°.

21. A method for emitting light outwardly in an exit direction over an azimuthal angle of at least 90° comprising:
providing a plurality of light emitting elements positioned adjacent each other;
providing a light transmitting element; wherein the light transmitting element receives a beam of light emitted from the plurality of light emitting elements in a direction along an entrance axis of the light transmitting element, wherein an exit direction is a direction along an exit axis of the light transmitting element, wherein the exit axis is oriented transverse with respect to the entrance axis of the light transmitting element, wherein an entrance surface divides the beam of light in at least two subbeams; of which at least one subbeam is reflected at least twice by first and second reflecting surfaces to redirect the subbeam in the exit direction and of which at least one subbeam is reflected at least once by a third reflecting surface to redirect the subbeam in the exit direction.

22. A method for exposing a hazard to aeronautical or marine navigation, the method comprising marking an obstruction, which presents the hazard, with the beacon light of claim 14.
